(19) United States
(12) Patent Application Publication
(10) Pub. No.: US 2026/0161957 A1
(43) Pub. Date: Jun. 11, 2026

(54) TRANSFER LEARNING IN A MACHINE-LEARNING MODEL

(71) Applicant: Analog Devices, Inc, Wilmington, MA (US)

(72) Inventors: Varun Kelkar, Medford, MA (US); Melihcan Erol, Cambridge, MA (US); Ravi Kiran Raman, Belmont, MA (US); Omer Tanovic, Acton, MA (US)

(21) Appl. No.: 19/183,315

(22) Filed: Apr. 18, 2025

Related U.S. Application Data
(60) Provisional application No. 63/635,865, filed on Apr. 18, 2024.

(51) Int. Cl. G06N 3/096

(52) U.S. Cl. CPC G06N 3/096

(57) ABSTRACT

System and techniques to enable transfer learning for machine-learning model interoperability are described herein. Data in a target domain is subjected to a transport process that shifts the data towards a source domain. The transport process includes creating synthetic data based on a portion of the target domain data and a constraint. A transformation is applied to a combination of the synthetic data and the original data that shifts the combination into the source domain. An ML model, trained on the source domain, is invoked on the data that results from the transformation.

### CLAIM OF PRIORITY

This patent application claims the benefit of priority, under 35 U.S.C. § 119, to U.S. Provisional Application Ser. No. 63/635,865, titled “DOMAIN ADAPTATION VIA REGULARIZED OPTIMAL TRANSPORT” and filed on Apr. 18, 2024, the entirety of which is hereby incorporated by reference herein.

### TECHNICAL FIELD

Embodiments described herein generally relate to automated test equipment and more specifically to transfer learning in a machine-learning model.

### BACKGROUND

Automated Testing Equipment (ATE) in manufacturing can include computer-controlled systems designed to test or to validate the functionality, performance, or safety of products. ATE systems can be integrated into manufacturing workflows to perform electrical, mechanical, or functional testing with minimal human intervention. ATE can include end-of-line (EOL) testing, which verifies that a product meets required specifications, or can categorize a performance aspect of a product, after the final stage of assembly. EOL testing can include measurements such as voltage, current, impedance, or signal integrity depending on the product type. For example, in battery production, ATE systems can be used to test parameters such as state of charge, capacity, internal resistance, or thermal behavior to ensure compliance with performance and safety standards. ATE has been used for a variety of products, such as printed circuit boards, power modules, or sensors, where test coverage and repeatability help to maintain quality and reliability at high manufacturing volumes.

Artificial intelligence (AI) refers to a broad set of computational methods that enable machines to perform tasks typically requiring human intelligence, such as perception, decision-making, or pattern recognition. AI generally includes machine learning (ML), in which an ML model is trained using large datasets to identify patterns or make predictions. The training process usually involves optimizing model parameters (e.g., synaptic weights) to minimize errors between predicted outputs and actual outcomes, often using techniques such as gradient descent in supervised or unsupervised learning contexts. For example, ML models can be trained on labeled data to perform classification or regression tasks or on unlabeled data to uncover underlying structures (e.g., patterns). In automated testing applications, ML models can enhance the capabilities of traditional ATE by enabling predictive maintenance, anomaly detection, or adaptive testing strategies. For instance, ML models can analyze historical test data to identify patterns indicative of latent defects or forecast equipment failures, enabling more efficient test scheduling or reduced downtime.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for transfer learning in a machine-learning model, according to an embodiment.

FIG. 2 illustrates an example of transport from a target domain to a source domain, according to an embodiment.

FIG. 3. illustrates an example of smearing sparse data in a data domain, according to an embodiment.

FIG. 4 illustrates an example of machine learning to generate a transport from a latent data space embedding of target domain data to the latent data space embedding of target domain data, according to an embodiment.

FIG. 5 illustrates an example of inference of target domain data using a machine-learning model trained on source domain data, according to an embodiment.

FIG. 6 illustrates an example of inference of target domain data using a machine-learning model trained on source domain data transformed to the target domain using a transport map, according to an embodiment.

FIG. 7 illustrates a flow diagram of an example of a method for transfer learning in a machine-learning model, according to an embodiment.

FIG. 8 is a block diagram illustrating an example of a machine upon which one or more embodiments may be implemented.

### DETAILED DESCRIPTION

In general to produce effective ML models, the ML model training depends on large volumes of high-quality (e.g., accurate, well distributed across the problem domain, etc.) data to achieve accurate and generalizable performance. However, acquiring such data presents significant challenges in manufacturing environments. Data collection can be expensive or time-consuming, particularly when the data collection involves generating experimental test cases or capturing measurements across diverse product variants. Furthermore, data can be sparse for certain failure modes or rare defect classes, limiting the ability of ML models to be trained to properly address (e.g., accurately classify, predict, etc.) these scenarios. In many cases, labeled data requires expert annotation, which further increases cost and reduces scalability.

Transfer learning provides a mechanism to address these challenges by adapting knowledge from a data-rich source domain to a data-sparse target domain. This approach is especially useful when direct data acquisition for the target domain is limited or impractical. Techniques such as Optimal Transport can be used to align the distributions of source and target data, enabling more effective transfer of learned representations. Optimal Transport (OT) is a mathematical framework that finds the most efficient way to transform one probability distribution into another by minimizing a transport cost. In the ML context, OT can be used to align data distributions across different domains. This alignment helps models trained on a source domain generalize better to a target domain with different characteristics. For example, Sliced Wasserstein Optimal Transport offers a computationally efficient method to learn transformation maps between domains, enabling the reuse of existing model architectures and reducing the dependency on large-scale labeled data in the target domain. This capability enhances the practicality of deploying ML-driven improvements in automated testing across variable production scenarios.

While Sliced Wasserstein Optimal Transport enables efficient domain adaptation, Sliced Wasserstein Optimal Transport can sometimes be excessively powerful in mapping more distributed source domain data with the sparse data points in the target domain data, resulting in mappings that do not reflect meaningful structural relationships in the data. This issue can be particularly relevant when working with sensor data, where the measurement space in the target domain may be partially observed due to limitations in allowable test configurations or operational constraints. In such cases, the target distribution may be underrepresented or incomplete after Sliced Wasserstein Optimal Transport is applied.

To address the issues with Sliced Wasserstein Optimal transport, smear regularization can be applied to the target domain data to expand the observed data points by intelligently distributing or “smearing” data points in the target domain across the unobserved regions (e.g., gaps) of the domain. This technique enables more uniform distributional coverage of data in the target domain before Sliced Wasserstein Optimal transport is—or other types of Optimal Transports or transport (e.g., transformations) between the target and source domains are—applied without requiring additional measurements, improving the robustness and stability of the learned transformation map and enhancing the reliability of transfer learning in automated testing applications. Additional details and examples are described below.

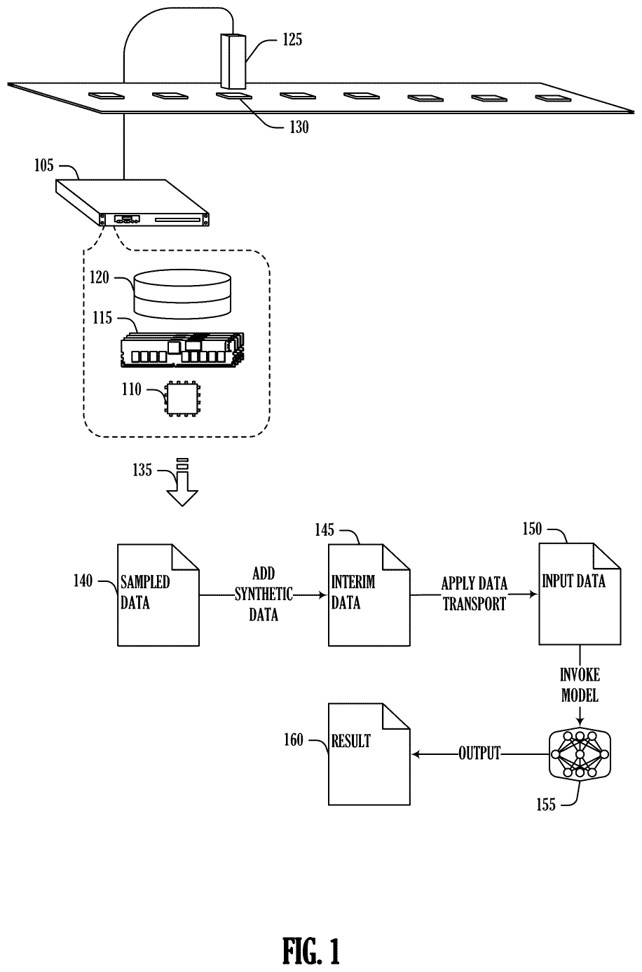

FIG. 1 is a block diagram of an example of an environment including a system 105 for transfer learning in an ML model 155, according to an embodiment. The system 105 includes processing circuitry 110, storage 120 (e.g., power-stable storage such as a hard drive, solid state drive, etc.), and memory 115. The memory 115 is generally used to maintain running state information for the system 105 that is usually discarded between system power cycles or restarts. The memory 115 and the storage 120 are both forms of computer readable media. The processing circuitry 110—or software residing in the memory 115 or storage 120 executing on the processing circuitry 110—configure the system 105 to perform various operations when in running (e.g., when in operation 135).

The system can include, be coupled to (e.g., via an interface), or receive data derived from a sensor 125. In the illustrated scenario, the sensor 125 can be part of an ATE component taking a measurement for a product 130. In an example, the measurement can be one of a set of measurements of the product 130. As noted above, in the context of manufacturing, such measurements can be used to verify compliance with requirements (e.g., manufacturing tolerances), to classify the product (e.g., into one of several a performance categories), or to otherwise aid in the manufacturing process. While the example illustrated and some examples discussed below are given in the context of manufacturing, the technique is generally applicable to improving transport processes used to apply the ML model 155 trained on a source domain to a target domain.

At a high level, the technique to improve transfer learning in an ML model involves smearing target domain data to improve the results of the transport function. Smearing creates synthetic data based on (e.g., anchored at) data points in the target domain data. This synthetic data provides additional elements for the transport process to operate upon, improving the results of the transport process and thus improving the performance of the ML model 155 on the transported target domain data. Thus, the processing circuitry 110 is configured to access media—such as the memory 115, the storage 120, a buffer in the sensor 125, etc. (e.g., via an interface)—that includes data in the target domain (e.g., the sampled data 140).

The term “target domain” here means the data domain targeted for use with ML model 155 and the “source domain” is the data domain upon which the ML model 155 was trained. These relationships generally arise when the target domain has insufficient data points to effectively train a model. Accordingly, in an example, the data in the target domain is sparse. Generally, sparsity refers to a proportion of present data to missing data in a dataset. This proportion can be estimated by the absence of data over a window in a dimension of the target domain. For example, if the dimension were human height and there were no values between five feet and six feet, this window in the dimension of height is missing data because it is expected but missing. In an example, “sparse” means that the data includes a gap (e.g., a window of missing information) beyond a threshold (e.g., the gap has a magnitude within a dimension) within the target domain.

The processing circuitry 110 is configured to execute a transport process on the data from the target domain to shift the data towards a source domain and create input data 150. The directionality of the shift can go either way (e.g., from target domain to source domain or from source domain to target domain), but it is usually more efficient to transport (e.g., transform, translate, etc.) the target data to the source domain because there is usually less target domain data. The result is called “input data” because it will be the data operated upon, or used as input to, the ML model 155.

The transport process here involves one or more sub-processes. In an example, the transport process includes the processing circuitry 110 configured to create synthetic data based on a portion of the data from the target domain (e.g., the sampled data 140) and a constraint. For example, the synthetic data can include a copy of a data point in the sampled data 140 that is shifted in a dimension of the target domain such that, if the data appoint value is 1, the value of the copy can be 2, for example. The constraint limits the bounds of the synthetic data. For example, the constraint can be based on the original data point and the constraint limits how different the synthetic data can be. Using the previous example, the data point value can have a sequentially increasing integer added to it for a set of synthetic data points up to the constraint. Thus, if the constraint is 5, and the original data point is 8, then the synthetic data can include values at 9, 10 11, 12, and 13. These simple examples are merely illustrative of the way in which a data point in the target domain is used along with the constraint to generate (e.g., define) synthetic data points.

The synthetic data is intended to provide a more-complete data set upon which the transport is applied. Thus, in an example, where the data in the target domain is sparse and the synthetic data fills a portion of the gap in the source data. In an example, the portion of the data is at an edge of the gap. In this example, creating the synthetic data based on the portion of the data includes smearing the portion of the data to fill the portion of the gap. Smearing, in this case, means to create synthetic data in such a way that a greater concentration of synthetic data points is closer to the data point in the target domain (e.g., the sampled data 140) and the synthetic data points become more dispersed the farther away from the data point. User the integer example above, synthetic data points can be added in the dimension with a spacing that doubles each iteration. For example, if the data point is 1, and the step starts at 0.25, then the first synthetic data point is at 1.25, the next is at 1.75 (e.g., 0.25 is doubled to 0.5 and added to 1.25), the third is at 2.25, and so on until the constraint is reached. Smearing provides a concentration of synthetic data centered at obtained measurements and reduces the impact of the synthetic data points the further away from the known data points in the target domain data the synthetic data points get.

In an example, the constraint is a distribution of values. In an example, the distribution is a Gaussian distribution. Such distributions often mirror the characteristics, or can be chosen to mirror the characteristics, of the source domain. This enables a better target domain data set from which to determine a transport to the source domain. In an example, the distribution is based on in a dimension of the source domain. This example enables value distributions in the source domain to influence how much smearing to apply in the target domain synthetic data. In an example, creating the synthetic data based on the constraint includes maintaining the distribution when creating new values in a dimension of the synthetic data. In an example, the constraint is a configurable parameter obtained from a configuration or a user interface. This last example illustrates that the distribution is a parameter of the synthetic generation process. Here, a configuration file, or a user interface, can be used such that a user can select which distribution (e.g., type or parameters) to apply as the constraint.

The processing circuitry 110 is configured to combine the synthetic data with the data from the target domain (e.g., the sampled data 140) to create interim data 145. This combination can be incorporated into the creation of the synthetic data (e.g., each synthetic data point created is added to the interim data 145 as the synthetic data points are created, as a buffer fills during creation, etc.) or a completely separate (e.g., all synthetic data is created and then added to the sampled data 140 to create the interim data 145). Also, way in which the data is stored can take different forms. For example, the synthetic data can be added directly to a data structure already housing the sampled data 140, or a completely new data structure (e.g., file, database, etc.) can be used.

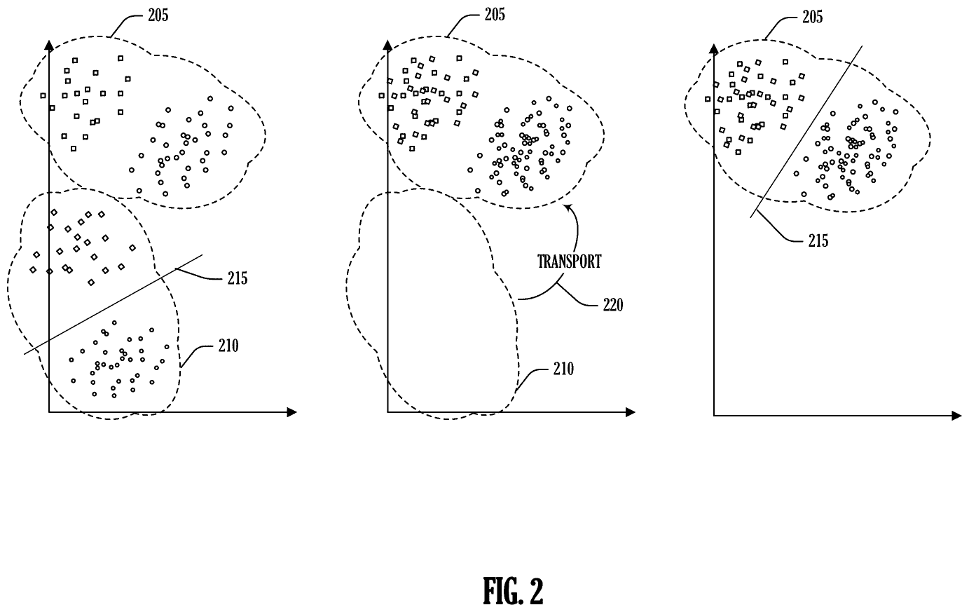

The processing circuitry 110 is configured to apply a transformation to the interim data 145 to shift the interim data to the source domain. This transformation is the “transport” in the transport process. FIG. 2 provides an example illustration of transport from one domain to another. The transformation includes a translation, a rotation, a scale change, or other operations to “fit” data points in the target domain to the source domain. In an example, the transformation is created through training process to map a data point from the target domain to a corresponding data point in the target domain. In an example, Sliced Wasserstein Optimal Transport (SWOT) is used as a loss function in the training process to obtain an optimal transport from the target domain to the source domain. In an example, the transformation represented by a transport map. In an example, the transfer map is a function that defines how to move or reassign probability mass from a source probability distribution to a target probability distribution in a way that minimizes a transportation cost (e.g., the Wasserstein distance in the context of in the context of Sliced Wasserstein Optimal Transport).

Although the previous examples do not specify the form of the data (e.g., the target data points or sampled data 140, the interim data 145, etc.) takes, several forms are possible. For example, the data sampled from the sensor 125 can be cleaned, normalized, or otherwise pre-processed. In an example, the data is represented a latent data space.

Modern ML techniques often operate upon latent data spaces. In general, latent data spaces are representations (e.g., compressed representations) of input data that capture underlying features or patterns in the input data. Latent data spaces generally are not directly observable but are learned by models during training to represent complex data distributions more compactly. Latent data spaces are typically created by neural network architectures such as autoencoders, variational autoencoders (VAEs), or generative adversarial networks (GANs). In these models, the encoder usually maps high-dimensional input data into a lower-dimensional latent space, where similar inputs tend to have similar latent representations. The latent data space enables tasks such as clustering, interpolation, generation, or anomaly detection. The decoder or generator can then reconstruct or synthesize data from the latent representations. Latent data spaces enable models to generalize from observed examples, facilitate efficient computation, or support interpretability by revealing structure in the data. Thus, in an example, the processing circuitry 110 is configured to invoke an encoder on the source data or the interim data 145 to produce an embedding (e.g., vector representation) for the input data 150 to a latent data space. In an example, the transport process accepts the embedding as input (e.g., the embedding is performed on the sampled data 140 prior to the generation of synthetic data). In an example, the ML model 155 is configured to perform an inference on the latent data space to produce a result.

The processing circuitry 110 is configured to invoke the ML model 155 on the input data 150 to obtain a result 160. As noted above, the ML model 155 was trained, or partially trained, on data from the source domain to produce output. The aforementioned techniques enables the use of the ML model 155 to perform an effective inference (or other ML output) on data from the target domain without training on the target domain. Due to the expensive model training, such transfer learning enables models trained once to be applied to many target domains. By using the synthetic data generation (e.g., smearing) noted above, target domains with sparse data can be adapted to use the ML model 155, further expanding the reusability of the ML model 155 and avoiding unnecessary training or delay.

The techniques noted herein can be useful in industries where different configurations of a product are produced. In an example, the source domain is a first set of measurements for a first product and the target domain is a second set of measurements for a second product. In an example, the first product and the second product are different products of a same type. In an example, the same type is a battery. Here, in an example, the first product has a different chemistry or a different form factor than the second product. In an example, the first set of measurements and the second set of measurements include respective electrochemical impedance spectroscopy (EIS) data, voltage, current, or state-of-charge data for the first product and the second product. In an example, the result is a core temperature of the battery. Thus, consider a source domain of EIS data from a battery cycled over many cycles and temperatures, and a target domain of EIS data from a battery with different form factor and chemistry cycled over a fewer cycles and temperatures. The task can be to estimate battery core temperature from EIS data using an ML model trained on the source domain. Consider data obtained for early life electrical data from Li-ion batteries, the data including EIS and voltage, current and state of charge (SoC) data. The source domain could correspond to 100 Amp-hour (Ah) lithium ion (Li-ion) Nickel Manganese Cobalt Aluminum oxide (NMCA) pouch cell and the target domain could correspond to 65 Ah Li-ion Nickel Manganese Cobalt oxide (NMC) pouch cell with different EIS characteristic.

FIG. 2 illustrates an example of transport from a target domain to a source domain, according to an embodiment. The original state, on the left, includes a source domain 205 and a target domain 210. The marker 215 demonstrates a relationship between the square data points and the circle data points in the target domain 210. The transport 220 (e.g., a transport map) is applied to the data points in the target domain 210 to transport these data points to the source domain 205. The rightmost portion includes the marker 215 in the source domain 205 to illustrate that the transport 220 preserved the relative relationship between the square data points and the circle data points from the target domain 210 in the source domain 205.

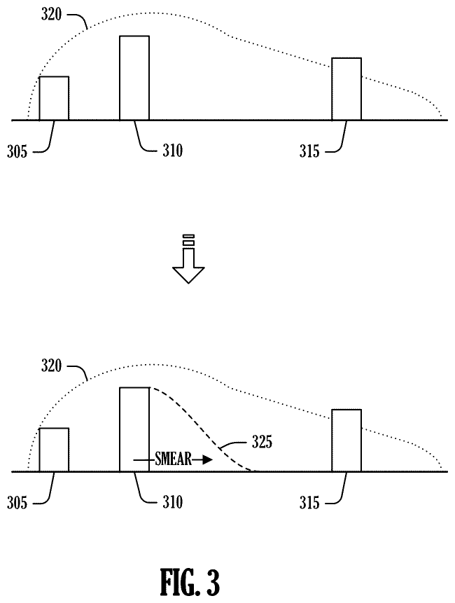

FIG. 3. illustrates an example of smearing sparse data in a data domain, according to an embodiment. An issue can arise in the transport (e.g., as illustrated in FIG. 2) where sparse data results in distortions in the transported datapoints. To address this issue, the data in the sparse domain can be smeared (e.g., synthetic data representing a gradient from the existing data points) can be used to fill out the sparse domain prior to calculating the transport. As illustrated, consider the sparse domain 320 with sparse data points, data point 305, data point 310, and data point 315. If the distance between data point 305 and 310 is expected, it is evident that there is missing data between the data point 310 and the data point 315. This gap can be defined in different ways, including a predefined threshold.

The bottom portion of FIG. 3 illustrates application of a distribution constraint on synthetic data 325 based the data point 310 to help fill in the gap. Although not illustrated, a similar constraint on a distribution in the other direction could be anchored at the data point 315 to further help fill in the gap. The type of distribution used as a constraint can depend upon expected values for the sparse domain 320, on measured values for a source domain, or upon other factors. Example distributions can include Gaussian, Bernoulli, Binomial, Poisson, Exponential, Gamma, Beta, or Dirichlet distributions among others. The Gaussian distribution, also known as the normal distribution, is defined by its mean and variance and is symmetric around the mean, often used for modeling continuous data with a central tendency. The Bernoulli distribution models binary outcomes and is parameterized by a single probability of success. The Binomial distribution extends the Bernoulli distribution to a fixed number of independent trials with the same success probability. The Poisson distribution models count data or the number of rare events occurring within a fixed interval. The Exponential distribution models the time between independent events that occur at a constant average rate. The Gamma distribution generalizes the Exponential distribution to model waiting times for multiple events and is characterized by shape and rate parameters. The Beta distribution models random variables constrained to the interval [0, 1] and is often applied in Bayesian inference. The Dirichlet distribution generalizes the Beta distribution to multivariate settings and is used to model probability vectors over a finite number of categories.

With the examples illustrated in FIG. 2 and FIG. 3, the following is an example where a Gaussian distribution is used to smear target domain data before a Sliced Wasserstein Optimal Transport is learned to transport the target domain to the source domain for inference by a model trained on the source domain. The example also discusses fine-tuned training of the model (e.g., few shot learning) with the smeared target domain data to enable a more direct inference by the model on data from the target domain. As noted above, ML effectiveness is often primarily determined by the volume and quality of data available for training. However, in many practical scenarios, acquiring such data can be cost-prohibitive, time-intensive, or infeasible, which limits the development of accurate ML-based inference models. Transfer learning addresses this constraint by adapting models trained in a data-rich source domain for use in a data-sparse target domain. In sensor-based monitoring systems inference techniques can be deployed in varying environments, each with different data characteristics. Applying transfer learning in these settings can reduce the need for independent data collection or model training (e.g., retraining) in each context. This reduction lowers the cost of deployment and accelerates development. The following example illustrates using transfer learning in the estimation of battery core temperature using electrochemical impedance spectroscopy (EIS) measurements, for example, when only limited data is available for a target domain of a different battery construction than that of the source domain. In an example, this approach has been used to address the problem of estimating battery core temperature using EIS data, where sufficient training data exist for one battery type, but only limited data are available for a battery with different physical and chemical characteristics.

Transfer learning for estimation tasks can be formulated as follows. Let x∈ [symbol] represent an observation vector drawn from the distributions

$${p}_{x}^{S} and {p}_{x}^{T}$$

corresponding to the source and target domains, respectively. Let y∈ [symbol] be the property inferred from x, with its distribution p_{y} assumed to be the same in both domains. Define w=(x,y) and the corresponding joint distributions

$${p}_{w}^{S} and {p}_{w}^{T}$$

in the source and target domains. Here, it is assumed that sufficient source-domain data is available to train a regressor f_{θ} such that f_{θ(x)}≈y with acceptable accuracy, while only limited target-domain data exist. The goal of the transfer learning process is to adapt f_{θ} to estimate y from samples

$$x ∼ {p}_{x}^{T} .$$

In this example, a two-step approach is used. First, a transformation Ω is learned to map source-domain samples

$${w}^{S} = ( {x}^{S} , {y}^{S} ) ∼ {p}_{w}^{S}$$

to the target domain. Second, f_{θ} is retrained using both the transformed source data and the available target-domain data.

To learn the transformation Ω, an optimal transport (OT) framework is employed. OT searches for a transportation plan γ″ that maps mass from p_{w}_{_{S}} to p_{w}_{_{T}}, minimizing the expected squared Euclidean distance:

$${γ}^{*} = arg {min}_{γ} {𝔼}_{( w , z ) ∼ γ} {‖ w - z ‖}_{2}^{2}$$

subject to from p_{w}_{_{S}} to p_{w}_{_{T}} being the marginals of γ.

In cases where both distributions are Gaussian, OT yields a linear mapping:

$${Ω}^{*} ( {w}_{S} ) = {μ}_{T} + A ( {w}_{S} - {μ}_{S} )$$

$$A = {\sum }_{S}^{- \frac{1}{2}} {( {\sum }_{S}^{\frac{1}{2}} {\sum }_{T} {\sum }_{S}^{\frac{1}{2}} )}^{\frac{1}{2}} {\sum }_{S}^{- \frac{1}{2}}$$

Where μ_{S}, μ_{T} and Σ_{S}, Σ_{T} are the means and covariances of the source and target distributions respectively.

If the data is better modeled as mixtures of Gaussians, the OT solution can be extended by computing pairwise linear transport maps {Ωᵢⱼ} between components of the source and target mixtures. A sample from the source can be mapped to the target using these transformations with probabilities Γᵢⱼ, determined by solving the discrete OT problem:

$${min}_{γ} {\sum }_{i = 1}^{{n}_{S}} {\sum }_{j = 1}^{{n}_{T}} {Γ}_{i j} {W}_{i j}$$

$$s . t . {\sum }_{j = 1}^{{n}_{T}} {Γ}_{i j} = {π}_{S} , {\sum }_{i = 1}^{{n}_{S}} {Γ}_{i j} = {π}_{T}$$

where π_{S} and π_{T} are the mixture weights, and Wᵢⱼ is the Wasserstein distance between the i-th and j-th Gaussian components in the source and target domains. This approach can be called a mixture of linear optimal transports (MOLT). In an example, additional constraints can be applied to Γ to control the flexibility of the MOLT mapping. The probabilities represented by Γ are a form of smearing in which the synthetic data points are generated during the transport calculation. Here, the generation of the synthetic data can be considered “ephemeral” as they need not be recorded or added to a data structure holding the target domain data, but rather exist to influence the mapping directly.

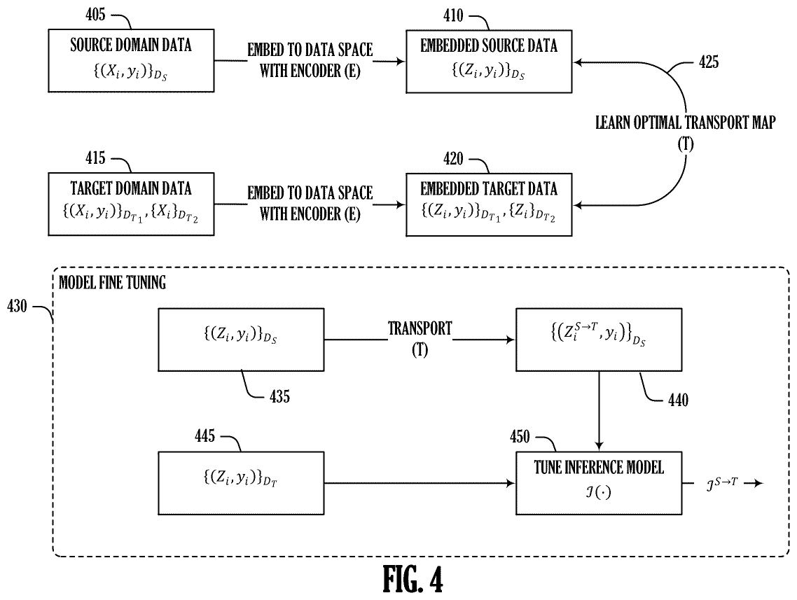

FIG. 4 illustrates an example of machine learning to generate a transport from a latent data space embedding of target domain data to the latent data space embedding of source domain data, according to an embodiment. As illustrated, source domain data 405 is encoded (e.g., reduced by an encoder) to create embedded source data 410. Similarly, target domain data 415 is encoded (e.g., using the same encoder used to encode the source domain data 405) to create embedded target data. Then, an optimal transport process (e.g., such as that described above) is applied to learn a transport map 425 from the embedded target data 420 to the embedded source data 410, or vice versa. The operation on the latent data space can reduce components because, generally, the latent data space is a lower-dimensional space than the original data space (e.g., the source domain).

The directionality of the transport map 425 can be used for different purposes. For example, mapping the source domain to the target domain enables the source domain data to supplement the target domain data to train, or re-train, the ML model on the target domain. This example is illustrated in the model fine tuning 430. Here, the source domain data 435 is transported to the target domain 440 and combined with target domain data 445 to tune the inference model 450. This approach can be useful when, for example, additional target domain data is used, over time, to continue to hone the model specifically for the target domain.

Conversely, mapping the target domain to the source domain enables the ML model to operate on the transported target domain data as if it were source domain data to provide an inference. This approach can be useful when, for example, the same model will be applied (e.g., infrequently) to different target domains. In this case, it is unlikely that the additional work to fine-tune models for each domain will be worth the time or expense when the target domain data can simply be transported to the source domain to get result from the ML model.

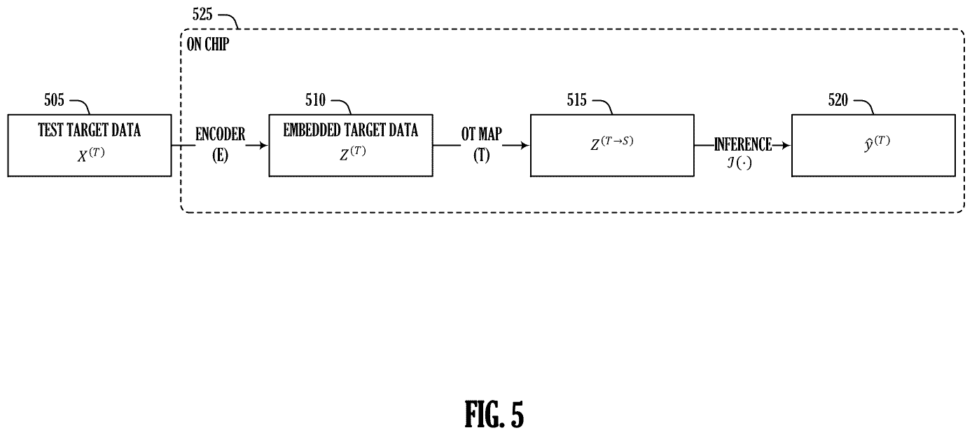

FIG. 5 illustrates an example of inference of target domain data 505 using an ML learning model trained on source domain data, according to an embodiment. The target domain data 505 (e.g., ATE test data) can be obtained (e.g., retrieved, received, delivered, etc.) by an ML pipeline (e.g., implemented in an on-chip accelerator 525). In the illustrated example, an encoder is invoked on the target domain data 505 to create embedded target data 510. The transport map (e.g., described above including the smearing of the embedded target data 510) transports the embedded target data 510 to the source domain to create an embedded representation 515 upon which the ML model can operate (e.g., accept as input) to produce a result 520. This configuration leverages on-chip models trained on the source domain to the target domain.

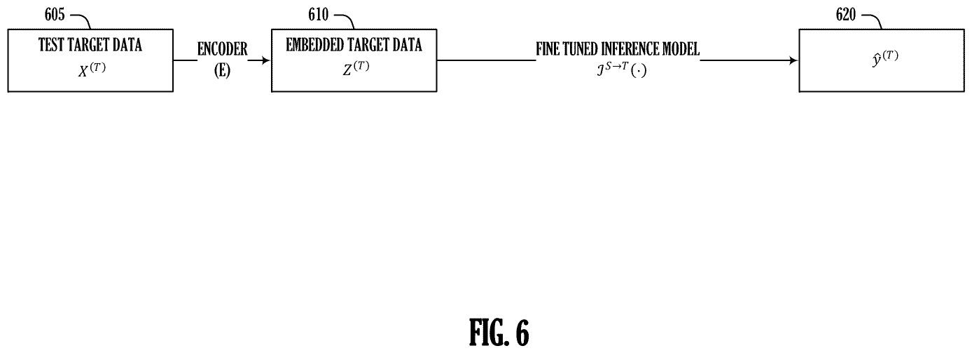

FIG. 6 illustrates an example of inference of target domain data using a machine-learning model trained on source domain data transformed to the target domain using a transport map, according to an embodiment. In this embodiment, the ML model is retrained for the target domain using data from the source domain that has been transported into the target domain. The retrained model is illustrated as [symbol] ^{→T}. Here, the target data can be processed by the retrained model directly. Thus, the target domain data 605 is obtained and encoded to the latent data space to create the embedded target data 610. The retrained model then operates directly on the target data embedding to produce the result 620.

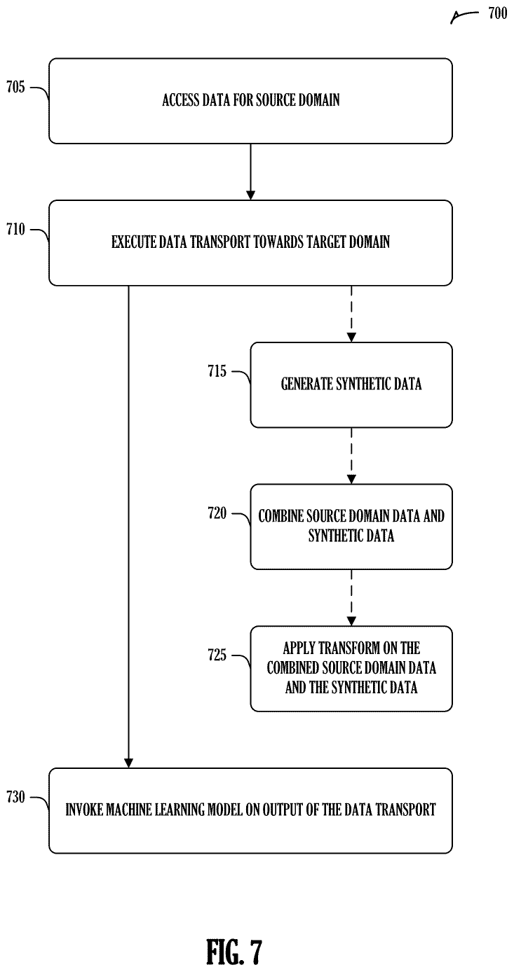

FIG. 7 illustrates a flow diagram of an example of a method 700 for transfer learning in a machine-learning model, according to an embodiment. The operations of the method 700 are performed by computer hardware such as that described above or below (e.g., processing circuitry).

At operation 705, media that includes data in a target domain is accessed. In an example, the data is sparse in the target domain. Here, being “sparse” means that the data includes a gap (e.g., missing information) beyond a threshold within the target domain.

At operation 710, a transport process is executed on the data to shift the data towards a source domain and create input data.

The transport process includes the operations 715-725. At operation 715, synthetic data is created based on a portion of the data and a constraint. In an example, where the data in the target domain is sparse, the synthetic data fills a portion of the gap in the source data. In an example, the portion of the data is at an edge of the gap. In this example, creating the synthetic data based on the portion of the data includes smearing the portion of the data to fill the portion of the gap.

In an example, the constraint is a distribution of values. In an example, the distribution is a Gaussian distribution. In an example, the distribution is based on in a dimension of the source domain. In an example, creating the synthetic data based on the constraint includes maintaining the distribution when creating new values in a dimension of the synthetic data. In an example, the constraint is a configurable parameter obtained from a configuration or a user interface.

In an example, the operations of the method 700 can include invoking an encoder on the source data or the interim data to produce an embedding for the input data to a latent data space. In an example, the transport process accepts the embedding as input. In an example, the ML model used in operation 730 is configured to perform an inference on the latent data space to produce the result.

At operation 720, the synthetic data is combined with the data to create interim data.

At operation 725, a transformation is applied to the interim data to shift the interim data to the source domain. In an example, the transformation is created through training process to map a data point from the target domain to a corresponding data point in the target domain. In an example, Sliced Wasserstein Transport (SWT) is used as a loss function in the training process to obtain an optimal transport from the target domain to the source domain.

At operation 730, a machine-learning model is invoked on the input data to obtain a result. This machine-learning model was trained on data from the source domain to produce output.

In an example, the source domain is a first set of measurements for a first product and the target domain is a second set of measurements for a second product. In an example, the first product and the second product are different products of a same type. In an example, the same type is a battery, and the first product has a different chemistry or a different form factor than the second product. In an example, the first set of measurements and the second set of measurements include respective electrochemical impedance spectroscopy (EIS) data, voltage, current, or state-of-charge data for the first product and the second product. In an example, the result is a core temperature of the battery.

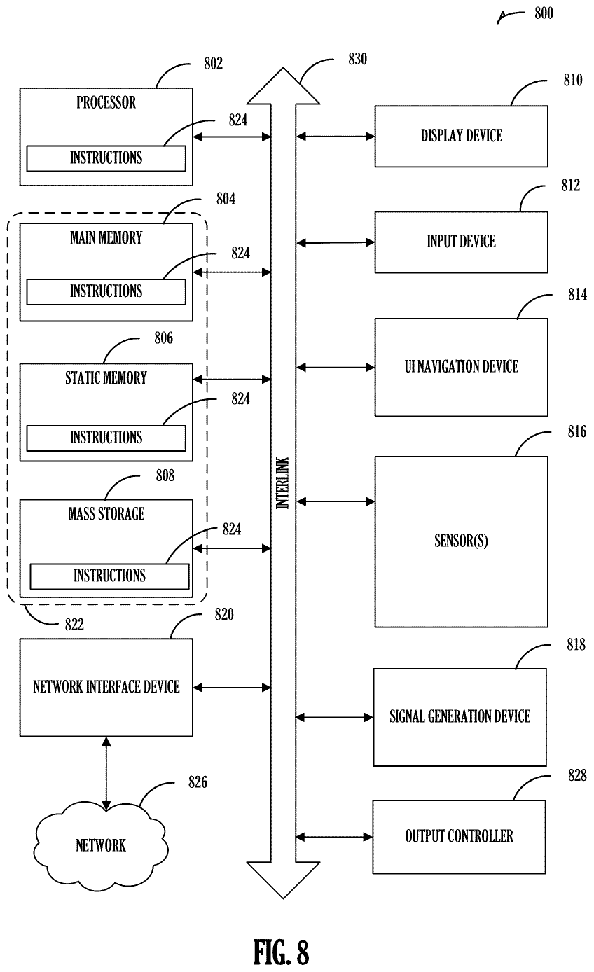

FIG. 8 illustrates a block diagram of an example machine 800 upon which any one or more of the techniques (e.g., methodologies) discussed herein may perform. Examples, as described herein, may include, or may operate by, logic or a number of components, or mechanisms in the machine 800. Circuitry (e.g., processing circuitry) is a collection of circuits implemented in tangible entities of the machine 800 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 800 follow.

In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 800 may include a hardware processor 802 (e.g., a central processing unit (CPU), a graphics processing unit (GPU), a hardware processor core, or any combination thereof), a main memory 804, a static memory (e.g., memory or storage for firmware, microcode, a basic-input-output (BIOS), unified extensible firmware interface (UEFI), etc.) 806, and mass storage 808 (e.g., hard drives, tape drives, flash storage, or other block devices) some or all of which may communicate with each other via an interlink (e.g., bus) 830. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 808, a signal generation device 818 (e.g., a speaker), a network interface device 820, and one or more sensors 816, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 802, the main memory 804, the static memory 806, or the mass storage 808 may be, or include, a machine readable medium 822 on which is stored one or more sets of data structures or instructions 824 (e.g., software) embodying or utilized by any one or more of the techniques or functions described herein. The instructions 824 may also reside, completely or at least partially, within any of registers of the processor 802, the main memory 804, the static memory 806, or the mass storage 808 during execution thereof by the machine 800. In an example, one or any combination of the hardware processor 802, the main memory 804, the static memory 806, or the mass storage 808 may constitute the machine readable media 822. While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 822 may be representative of the instructions 824, such as instructions 824 themselves or a format from which the instructions 824 may be derived. This format from which the instructions 824 may be derived may include source code, encoded instructions (e.g., in compressed or encrypted form), packaged instructions (e.g., split into multiple packages), or the like. The information representative of the instructions 824 in the machine readable medium 822 may be processed by processing circuitry into the instructions to implement any of the operations discussed herein. For example, deriving the instructions 824 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 824.

In an example, the derivation of the instructions 824 may include assembly, compilation, or interpretation of the information (e.g., by the processing circuitry) to create the instructions 824 from some intermediate or preprocessed format provided by the machine readable medium 822. The information, when provided in multiple parts, may be combined, unpacked, and modified to create the instructions 824. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 824 may be further transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software. A transmission medium is a machine readable medium.

### ADDITIONAL NOTES & EXAMPLES

Example 1 is a device for transfer learning in a machine-learning (ML) model, the device comprising: an interface configured to access media that includes data in a target domain; a memory including instructions; and processing circuitry that, when in operation, is configured by the instructions to: execute a transport process on the data to shift the data towards a source domain and create input data, the transport process including: creating synthetic data based on a portion of the data and a constraint; combining the synthetic data with the data to create interim data; and applying a transformation to the interim data to shift the interim data to the source domain; and invoke a ML model on the input data to obtain a result, the ML model trained on data from the source domain to produce output.

In Example 2, the subject matter of Example 1, wherein the data is sparse in the target domain, the data sampled non-uniformly in the target domain label space including a gap beyond a threshold.

In Example 3, the subject matter of Example 2, wherein the synthetic data fills a portion of the gap in the target domain.

In Example 4, the subject matter of Example 3, wherein the portion of the data is at an edge of the gap, and wherein, to create the synthetic data based on the portion of the data, the processing circuitry is configured to smear the portion of the data to fill the portion of the gap.

In Example 5, the subject matter of any of Examples 1-4, wherein the constraint is a distribution of values.

In Example 6, the subject matter of Example 5, wherein, to create the synthetic data based on the constraint, the processing circuitry is configured to maintain the distribution when creating new values in a dimension of the synthetic data.

In Example 7, the subject matter of any of Examples 1-6, wherein the constraint is a configurable parameter obtained from a configuration or a user interface.

In Example 8, the subject matter of any of Examples 1-7, wherein the transformation is created through training process to map a data point from the target domain to a corresponding data point in the target domain.

In Example 9, the subject matter of Example 8, wherein Sliced Wasserstein Transport (SWT) is used as a loss function in the training process to obtain an optimal transport from the target domain to the source domain.

In Example 10, the subject matter of any of Examples 1-9, wherein the processing circuitry is configured to invoke an encoder on the data or the interim data to produce an embedding for the input data to a latent data space, wherein the transport process accepts the embedding as input.

In Example 11, the subject matter of Example 10, wherein the ML model is configured to perform an inference on the latent data space to produce the result.

In Example 12, the subject matter of any of Examples 1-11, wherein the source domain is a first set of measurements for a first product and the target domain is a second set of measurements for a second product.

In Example 13, the subject matter of Example 12, wherein the first product and the second product are different products of a same type.

In Example 14, the subject matter of Example 13, wherein the same type is a battery, and wherein the first product has a different chemistry or a different form factor than the second product.

In Example 15, the subject matter of Example 14, wherein the first set of measurements and the second set of measurements include respective electrochemical impedance spectroscopy (EIS) data, voltage, current, or state-of-charge data for the first product and the second product.

In Example 16, the subject matter of Example 15, wherein the result is a core temperature of the battery.

Example 17 is a method for transfer learning in a machine-learning (ML) model, the method comprising: accessing media that includes data in a target domain; executing a transport process on the data to shift the data towards a source domain and create input data, the transport process including: creating synthetic data based on a portion of the data and a constraint; combining the synthetic data with the data to create interim data; and applying a transformation to the interim data to shift the interim data to the source domain; and invoking a ML model on the input data to obtain a result, the ML model trained on data from the source domain to produce output.

In Example 18, the subject matter of Example 17, wherein the data is sparse in the target domain, the data sampled non-uniformly in the target domain label space including a gap beyond a threshold.

In Example 19, the subject matter of Example 18, wherein the synthetic data fills a portion of the gap in the target domain.

In Example 20, the subject matter of Example 19, wherein the portion of the data is at an edge of the gap, and wherein creating the synthetic data based on the portion of the data includes smearing the portion of the data to fill the portion of the gap.

In Example 21, the subject matter of any of Examples 17-20, wherein the constraint is a distribution of values.

In Example 22, the subject matter of Example 21, wherein creating the synthetic data based on the constraint includes maintaining the distribution when creating new values in a dimension of the synthetic data.

In Example 23, the subject matter of any of Examples 17-22, wherein the constraint is a configurable parameter obtained from a configuration or a user interface.

In Example 24, the subject matter of any of Examples 17-23, wherein the transformation is created through training process to map a data point from the target domain to a corresponding data point in the target domain.

In Example 25, the subject matter of Example 24, wherein Sliced Wasserstein Transport (SWT) is used as a loss function in the training process to obtain an optimal transport from the target domain to the source domain.

In Example 26, the subject matter of any of Examples 17-25, comprising invoking an encoder on the data or the interim data to produce an embedding for the input data to a latent data space, wherein the transport process accepts the embedding as input.

In Example 27, the subject matter of Example 26, wherein the ML model is configured to perform an inference on the latent data space to produce the result.

In Example 28, the subject matter of any of Examples 17-27, wherein the source domain is a first set of measurements for a first product and the target domain is a second set of measurements for a second product.

In Example 29, the subject matter of Example 28, wherein the first product and the second product are different products of a same type.

In Example 30, the subject matter of Example 29, wherein the same type is a battery, and wherein the first product has a different chemistry or a different form factor than the second product.

In Example 31, the subject matter of Example 30, wherein the first set of measurements and the second set of measurements include respective electrochemical impedance spectroscopy (EIS) data, voltage, current, or state-of-charge data for the first product and the second product.

In Example 32, the subject matter of Example 31, wherein the result is a core temperature of the battery.

Example 33 is a system comprising means to perform any method of Examples 17-32.

Example 34 is a machine readable media including instructions that, when executed by processing circuitry, cause the processing circuitry to perform any method of Examples 17-32.

Example 35 is machine readable media including instructions for transfer learning in a machine-learning (ML) model, the instructions, when executed by processing circuitry, cause the processing circuitry to perform operations comprising: accessing media that includes data in a target domain; executing a transport process on the data to shift the data towards a source domain and create input data, the transport process including: creating synthetic data based on a portion of the data and a constraint; combining the synthetic data with the data to create interim data; and applying a transformation to the interim data to shift the interim data to the source domain; and invoking a ML model on the input data to obtain a result, the ML model trained on data from the source domain to produce output.

In Example 36, the subject matter of Example 35, wherein the data is sparse in the target domain, the data sampled non-uniformly in the target domain label space including a gap beyond a threshold.

In Example 37, the subject matter of Example 36, wherein the synthetic data fills a portion of the gap in the target domain.

In Example 38, the subject matter of Example 37, wherein the portion of the data is at an edge of the gap, and wherein creating the synthetic data based on the portion of the data includes smearing the portion of the data to fill the portion of the gap.

In Example 39, the subject matter of any of Examples 35-38, wherein the constraint is a distribution of values.

In Example 40, the subject matter of Example 39, wherein creating the synthetic data based on the constraint includes maintaining the distribution when creating new values in a dimension of the synthetic data.

In Example 41, the subject matter of any of Examples 35-40, wherein the constraint is a configurable parameter obtained from a configuration or a user interface.

In Example 42, the subject matter of any of Examples 35-41, wherein the transformation is created through training process to map a data point from the target domain to a corresponding data point in the target domain.

In Example 43, the subject matter of Example 42, wherein Sliced Wasserstein Transport (SWT) is used as a loss function in the training process to obtain an optimal transport from the target domain to the source domain.

In Example 44, the subject matter of any of Examples 35-43, wherein the operation comprise invoking an encoder on the data or the interim data to produce an embedding for the input data to a latent data space, wherein the transport process accepts the embedding as input.

In Example 45, the subject matter of Example 44, wherein the ML model is configured to perform an inference on the latent data space to produce the result.

In Example 46, the subject matter of any of Examples 35-45, wherein the source domain is a first set of measurements for a first product and the target domain is a second set of measurements for a second product.

In Example 47, the subject matter of Example 46, wherein the first product and the second product are different products of a same type.

In Example 48, the subject matter of Example 47, wherein the same type is a battery, and wherein the first product has a different chemistry or a different form factor than the second product.

In Example 49, the subject matter of Example 48, wherein the first set of measurements and the second set of measurements include respective electrochemical impedance spectroscopy (EIS) data, voltage, current, or state-of-charge data for the first product and the second product.

In Example 50, the subject matter of Example 49, wherein the result is a core temperature of the battery.

Example 51 is a system for transfer learning in a machine-learning (ML) model, the system comprising: means for accessing media that includes data in a target domain; means for executing a transport process on the data to shift the data towards a source domain and create input data, the transport process including: creating synthetic data based on a portion of the data and a constraint; combining the synthetic data with the data to create interim data; and applying a transformation to the interim data to shift the interim data to the source domain; and means for invoking a ML model on the input data to obtain a result, the ML model trained on data from the source domain to produce output.

In Example 52, the subject matter of Example 51, wherein the data is sparse in the target domain, the data sampled non-uniformly in the target domain label space including a gap beyond a threshold.

In Example 53, the subject matter of Example 52, wherein the synthetic data fills a portion of the gap in the target domain.

In Example 54, the subject matter of Example 53, wherein the portion of the data is at an edge of the gap, and wherein the means for creating the synthetic data based on the portion of the data include means for smearing the portion of the data to fill the portion of the gap.

In Example 55, the subject matter of any of Examples 51-54, wherein the constraint is a distribution of values.

In Example 56, the subject matter of Example 55, wherein the means for creating the synthetic data based on the constraint include means for maintaining the distribution when creating new values in a dimension of the synthetic data.

In Example 57, the subject matter of any of Examples 51-56, wherein the constraint is a configurable parameter obtained from a configuration or a user interface.

In Example 58, the subject matter of any of Examples 51-57, wherein the transformation is created through training process to map a data point from the target domain to a corresponding data point in the target domain.

In Example 59, the subject matter of Example 58, wherein Sliced Wasserstein Transport (SWT) is used as a loss function in the training process to obtain an optimal transport from the target domain to the source domain.

In Example 60, the subject matter of any of Examples 51-59, comprising means for invoking an encoder on the data or the interim data to produce an embedding for the input data to a latent data space, wherein the transport process accepts the embedding as input.

In Example 61, the subject matter of Example 60, wherein the ML model is configured to perform an inference on the latent data space to produce the result.

In Example 62, the subject matter of any of Examples 51-61, wherein the source domain is a first set of measurements for a first product and the target domain is a second set of measurements for a second product.

In Example 63, the subject matter of Example 62, wherein the first product and the second product are different products of a same type.

In Example 64, the subject matter of Example 63, wherein the same type is a battery, and wherein the first product has a different chemistry or a different form factor than the second product.

In Example 65, the subject matter of Example 64, wherein the first set of measurements and the second set of measurements include respective electrochemical impedance spectroscopy (EIS) data, voltage, current, or state-of-charge data for the first product and the second product.

In Example 66, the subject matter of Example 65, wherein the result is a core temperature of the battery.

Example 67 is at least one machine-readable medium including instructions that, when executed by processing circuitry, cause the processing circuitry to perform operations to implement of any of Examples 1-66.

Example 68 is an apparatus comprising means to implement of any of Examples 1-66.

Example 69 is a system to implement of any of Examples 1-66.

Example 70 is a method to implement of any of Examples 1-66.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device for transfer learning in a machine-learning (ML) model, the device comprising:
an interface configured to access media that includes data in a target domain;
a memory including instructions; and
processing circuitry that, when in operation, is configured by the instructions to:
execute a transport process on the data to shift the data towards a source domain and create input data, the transport process including:
creating synthetic data based on a portion of the data and a constraint;
combining the synthetic data with the data to create interim data; and
applying a transformation to the interim data to shift the interim data to the source domain; and
invoke a ML model on the input data to obtain a result, the ML model trained on data from the source domain to produce output.

2. The device of claim 1, wherein the data is sparse in the target domain, the data sampled non-uniformly in the target domain including a gap beyond a threshold.

3. The device of claim 1, wherein the constraint is a distribution of values.

4. The device of claim 3, wherein, to create the synthetic data based on the constraint, the processing circuitry is configured to maintain the distribution when creating new values in a dimension of the synthetic data.

5. The device of claim 1, wherein the constraint is a configurable parameter obtained from a configuration or a user interface.

6. The device of claim 1, wherein the processing circuitry is configured to invoke an encoder on the data or the interim data to produce an embedding for the input data to a latent data space, wherein the transport process accepts the embedding as input.

7. The device of claim 1, wherein the source domain is a first set of measurements for a first product and the target domain is a second set of measurements for a second product.

8. A method for transfer learning in a machine-learning (ML) model, the method comprising:
accessing media that includes data in a target domain;
executing a transport process on the data to shift the data towards a source domain and create input data, the transport process including:
creating synthetic data based on a portion of the data and a constraint;
combining the synthetic data with the data to create interim data; and
applying a transformation to the interim data to shift the interim data to the source domain; and
invoking a ML model on the input data to obtain a result, the ML model trained on data from the source domain to produce output.

9. The method of claim 8, wherein the data is sparse in the target domain, the data sampled non-uniformly in the target domain including a gap beyond a threshold.

10. The method of claim 8, wherein the constraint is a distribution of values.

11. The method of claim 10, wherein creating the synthetic data based on the constraint includes maintaining the distribution when creating new values in a dimension of the synthetic data.

12. The method of claim 8, wherein the constraint is a configurable parameter obtained from a configuration or a user interface.

13. The method of claim 8, comprising invoking an encoder on the data or the interim data to produce an embedding for the input data to a latent data space, wherein the transport process accepts the embedding as input.

14. The method of claim 8, wherein the source domain is a first set of measurements for a first product and the target domain is a second set of measurements for a second product.

15. Machine readable media including instructions for transfer learning in a machine-learning (ML) model, the instructions, when executed by processing circuitry, cause the processing circuitry to perform operations comprising:
accessing media that includes data in a target domain;
executing a transport process on the data to shift the data towards a source domain and create input data, the transport process including:
creating synthetic data based on a portion of the data and a constraint;
combining the synthetic data with the data to create interim data; and
applying a transformation to the interim data to shift the interim data to the source domain; and
invoking a ML model on the input data to obtain a result, the ML model trained on data from the source domain to produce output.

16. The machine readable media of claim 15, wherein the data is sparse in the target domain, the data sampled non-uniformly in the target domain including a gap beyond a threshold.

17. The machine readable media of claim 15, wherein the constraint is a distribution of values.

18. The machine readable media of claim 17, wherein creating the synthetic data based on the constraint includes maintaining the distribution when creating new values in a dimension of the synthetic data.

19. The machine readable media of claim 15, wherein the constraint is a configurable parameter obtained from a configuration or a user interface.

20. The machine readable media of claim 15, wherein the operations comprise invoking an encoder on the data or the interim data to produce an embedding for the input data to a latent data space, wherein the transport process accepts the embedding as input.

21. The machine readable media of claim 15, wherein the source domain is a first set of measurements for a first product and the target domain is a second set of measurements for a second product.
